(19) United States
(12) Patent Application Publication
(10) Pub. No.: US 2004/0239630 A1
(43) Pub. Date: Dec. 2, 2004

(54) Feedback to users of optical navigation devices on non-navigable surfaces

(76) Inventors: Ramakrishna Kakarala, Santa Clara, CA (US); Roopinder Singh Grewal, San Jose, CA (US); Vincent C. Moyer, Milpitas, CA (US)

Correspondence Address: AGILENT TECHNOLOGIES, INC., Legal Department, DL429, Intellectual Property Administration, P.O. Box 7599, Loveland, OH, 80537-0599, US

(21) Appl. No.: 10/449,783

(22) Filed: May 30, 2003

(51) Int. Cl. G09G 5/08

(52) U.S. Cl. 345/166

(57) ABSTRACT

Feedback is provided when an optical navigation device acquires an image that is not suitable for navigation purposes. An image sensor embedded within the optical navigation device acquires an image of a surface. An image monitor determines the navigability of the captured image and generates a signal indicative of the image's navigability. A comparator compares the signal to a threshold navigability level. When the image navigability is determined to be below the threshold and thus non-navigable, the comparator asserts a feedback signal. The feedback signal may trigger a variety of feedback mechanisms to alert the user that the surface is non-navigable. Possible feedback mechanisms include a warning message on a display screen, an illuminated light on the optical navigation device, or an audible sound.

### FIELD OF THE INVENTION

The invention is directed towards optical navigation, and more specifically, towards giving feedback when optical navigation is inaccurate.

### BACKGROUND OF THE INVENTION

Optical navigation is the process of determining motion by acquiring a series of images of a surface (or surfaces) with an image sensor, and then comparing images taken at different times to estimate the amount of motion that occurred in the elapsed time interval. Devices that use optical navigation include optical mice, handheld scanners, digital pens, etc. The accuracy of optical navigation depends on the type of surface that is scanned. On certain surfaces, it is difficult or even impossible for an optical navigation device to accurately determine motion. Some difficult surfaces include glossy, featureless, or repetitive or surfaces.

Glossy surfaces are difficult to navigate because they have very little visible surface texture, and therefore light reflecting off of the surface is not varied by any surface features that can be matched in displaced images to determine motion. Similarly, featureless surfaces, or surfaces with very few features, are also difficult to navigate because not enough surface features are available to match in displaced images. Repetitive surfaces such as certain wood grains, or half-tone images where ink dots are regularly spaced across a printing surface, are difficult to navigate as well, because the images taken of the surface at displacements related to the repetition spacing are almost identical and can cause false readings.

Currently, a user of an optical navigation device has no way of knowing whether the scanned surface is suitable for navigation. Consequently, the user may incorrectly blame the optical navigation device for being defective when tracking errors occur while scanning a non-navigable surface.

### SUMMARY OF THE INVENTION

In a preferred embodiment of the present invention, a user of an optical navigation device is given feedback when the image acquired by the device is not suitable for navigation purposes. An image sensor embedded within the optical navigation device acquires an image of a surface. An image monitor runs tests on the image and generates a signal indicative of the image's navigability. A comparator compares the signal to a threshold navigability level. When the image navigability is determined to be below the threshold and thus non-navigable, the comparator asserts a feedback signal. The feedback signal may trigger a variety of feedback mechanisms to alert the user that the surface is non-navigable.

Further features and advantages of the present invention, as well as the structure and operation of preferred embodiments of the present invention, are described in detail below with reference to the accompanying exemplary drawings. In the drawings, like reference numbers indicate identical or functionally similar elements.

### BRIEF DESCRIPTION OF THE DRAWINGS

FIG. 1 shows a preferred embodiment of a system made in accordance with the teachings of the present invention.

FIG. 2 illustrates a process flowchart according to the present invention.

### DETAILED DESCRIPTION

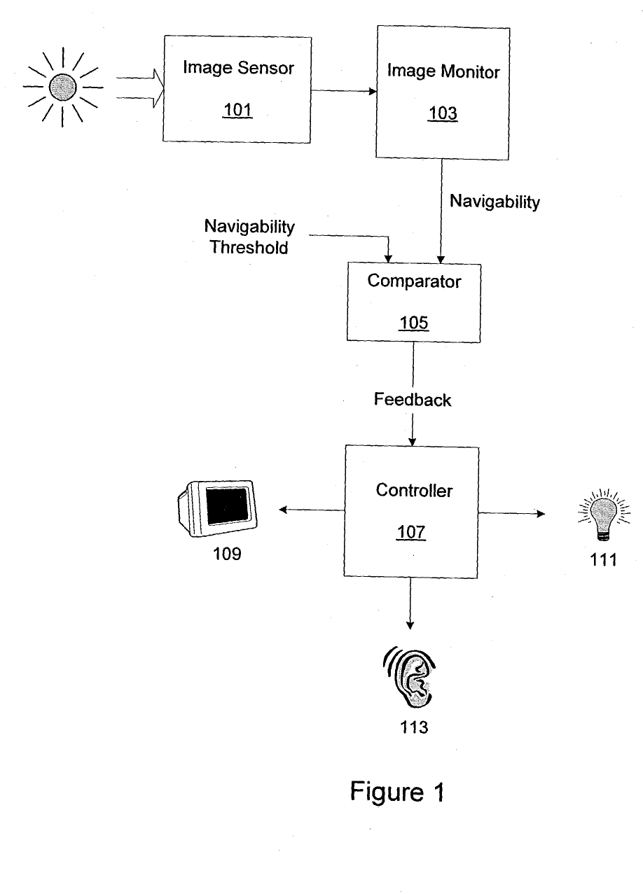

FIG. 1 shows a preferred embodiment of a system made in accordance with the teachings of the present invention. An optical navigation device houses an image sensor 101, which captures an image of a surface or surfaces. An image monitor 103 runs tests on the image and generates a navigability signal, which indicates how suitable the image is for navigation. A comparator 105 compares the navigability signal to a threshold navigability level and generates a feedback signal. When the navigability of the image exceeds the threshold, the feedback signal is inactive. When the image navigability is below the threshold, the comparator asserts a feedback signal.

The feedback signal can be routed to a controller 107, which controls one or more feedback mechanisms (109, 111, 113) in response to the feedback signal. A feedback mechanism alerts the user when the optical navigation device scans a non-navigable surface. For instance, if the optical navigation device is in communication with a computer having a display screen 109, the feedback mechanism can be a warning message or other visible indicator that appears on the display screen 109 when the optical navigation device is scanning a non-navigable surface. The feedback mechanism can simply be the illumination 111 of a light-emitting diode (LED), or other light source on the optical navigation device. The feedback mechanism can even be an audible sound 113 to alert the user about a non-navigable surface. Other visual, audio, and even tactile feedback mechanisms (such as a vibrating mechanism) are possible.

The image monitor 103 must be able to detect surfaces that make navigation difficult, such as glossy, featureless, or repetitive surfaces. The image monitor 103 runs a variety of tests on the images acquired of a surface to determine its suitability for navigation. For example, the image monitor 103 may calculate the average exposure level of the image to determine if it is over-exposed with reflected light, which might indicate a glossy surface. The image monitor 103 may run the image through a filter, or measure the uniformity of the image to determine if the surface has enough features for navigation.

To detect a repetitive surface, the image monitor 103 may run auto-correlation or cross-correlation on the image. Auto-correlation compares a mathematical model of an image with itself, whereas cross-correlation compares the mathematical models of two different images in a sequence of images acquired of a surface. Optical navigation devices commonly use cross-correlation to determine motion by detecting the shift between two images, and therefore already have the capability to run these tests. For more details regarding possible methods for detecting repetitive surfaces, see co-pending application serial # 10/250,722: Method for Detecting Repetitive Surfaces in an Optical Mouse. Other tests besides the ones described herein may be run by the image monitor to detect surfaces that may not be navigable by the optical navigation device.

The optical navigation device can be an optical mouse, an optical scanner, a digital pen, etc. The image monitor 103, comparator 105, and controller 107 may be implemented in hardware or software, as will be obvious to those skilled in the art.

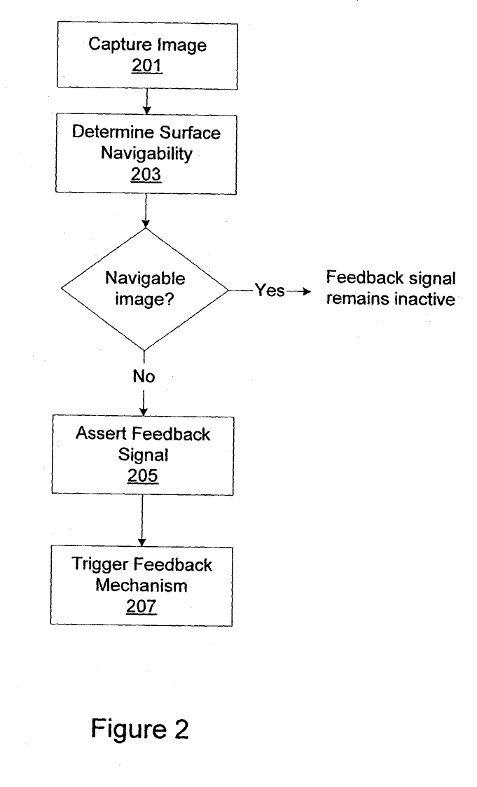

FIG. 2 illustrates a process flowchart according to the present invention. In step 201, an image is captured. In step 203, the navigability of the image is determined. When the image is non-navigable, a feedback signal is asserted (step 205) and a feedback mechanism is triggered (step 207). When the image is a navigable image, then the feedback signal remains inactive.

In an alternate embodiment of the present invention, multiple images are captured and tested for navigability before asserting the feedback signal. The feedback signal is only asserted if the images consistently indicate a non-navigable surface. This prevents false alarms if the optical navigation device is only momentarily passing over a non-navigable portion of the surface, or passing over a non-navigable surface before reaching a navigable one.

Although the present invention has been described in detail with reference to particular preferred embodiments, persons possessing ordinary skill in the art to which this invention pertains will appreciate that various modifications and enhancements may be made without departing from the spirit and scope of the claims that follow.

We claim:

1. A system, comprising:
an image sensor capturing an image;
an image monitor for determining the navigability of the captured image and generating a navigability signal which indicates how suitable the image is for navigation; and
a comparator for comparing a navigability threshold to the navigability signal and generating a feedback signal, wherein the feedback signal
is inactive when the navigability signal exceeds the navigability threshold, and
is asserted when the navigability signal is below the navigability threshold.

2. The system as in claim 1, further comprising:
a controller for controlling a feedback mechanism that is triggered in response to the feedback signal;

3. The system as in claim 2, further comprising:
an optical navigation device housing the image sensor

4. The system as in claim 3, wherein the optical navigation device is an optical mouse.

5. The system as in claim 3, wherein the optical navigation device is a scanner.

6. The system as in claim 3, wherein the feedback mechanism is a visible indicator displayed on a display screen.

7. The system as in claim 3, wherein the feedback mechanism is a light on the optical navigation device.

8. The system as in claim 3, wherein the feedback mechanism is an audible signal.

9. The system as in claim 1, wherein
the image sensor captures multiple images, and
the image monitor determines the navigability of multiple captured images and generates a navigability signal which indicates how suitable the multiple captured images are for navigation.

10. A method for giving feedback to a user of an optical navigation device, comprising:
capturing an image of a surface;
determining the navigability of the image;
asserting a feedback signal when the image is not suitable for navigation;

11. The method as in claim 10, further comprising:
triggering a feedback mechanism when the feedback signal is asserted.

12. The method as in claim 11, wherein triggering a feedback mechanism includes:
displaying a visible indicator on a display screen.

13. The method as in claim 11, wherein triggering a feedback mechanism includes:
illuminating a light on the optical navigation device.

14. The method as in claim 11, wherein triggering a feedback mechanism includes:
sounding an audible signal.

15. The method as in claim 10, wherein determining the navigability includes:
detecting a repetitive surface.

16. The method as in claim 15, wherein detecting a repetitive surface includes:
auto-correlating the image.

17. The method as in claim 15, wherein detecting a repetitive surface includes:
cross-correlating the image.

18. The method as in claim 10, wherein determining the navigability includes:
detecting a glossy surface.

19. The method as in claim 10, wherein determining the navigability includes:
detecting a featureless surface.

20. A method for giving feedback to a user of an optical navigation device, comprising:
capturing multiple images of a surface;
determining the navigability of the images;
asserting a feedback signal when the surface is not suitable for navigation;

21. The method as in claim 20, further comprising:
triggering a feedback mechanism when the feedback signal is asserted.
